(19) United States
(12) Patent Application Publication
(10) Pub. No.: US 2012/0257107 A1
(43) Pub. Date: Oct. 11, 2012

(54) ILLUMINATION DEVICE, LIQUID CRYSTAL DISPLAY DEVICE AND TELEVISION RECEIVER DEVICE

(75) Inventor: Kohji Itoh, Osaka-shi (JP)

(73) Assignee: SHARP KABUSHIKI KAISHA, Osaka-shi, Osaka (JP)

(21) Appl. No.: 13/518,400

(22) PCT Filed: Oct. 1, 2010
(86) PCT No.: PCT/JP2010/067207

§ 371 Date: Jun. 22, 2012

(30) Foreign Application Priority Data
Dec. 28, 2009 (JP) 2009-296785

(51) Int. Cl. H04N 5/44; F21V 29/00; G02F 1/13357; F21V 8/00

(52) U.S. Cl. 348/553; 362/617; 349/65

(57) ABSTRACT

In an illumination device (1) in which a light source (12) is arranged to the side of a light guide plate (11), which guides light that enters the light guide plate (11) through an entrance surface (11a) and which emits illumination light through an emission surface (11b), there are provided: a light guide plate assembly (10) that uses a holding member (13) so as to integrally hold the light source (12) and the light guide plate (11); and an enclosure (2) that houses the light guide plate assembly (10). Here, the position of the light guide plate assembly (10) in a direction of the thickness of the light guide plate assembly (10) is regulated by the inner surface of the enclosure (2), and a predetermined gap (S) in the direction of the thickness is provided between the inner surface of the enclosure (2) and the light guide plate assembly (10).

### TECHNICAL FIELD

The present invention relates to an edge light-type illumination device in which a light source is arranged to the side of a light guide plate, and a liquid crystal display device and a television receiver device using such an illumination device.

### BACKGROUND ART

A conventional illumination device is disclosed in patent document 1. FIG. 12 shows a side cross-sectional view of a liquid crystal display device incorporating such an illumination device. In the liquid crystal display device 50, the illumination device 1 is arranged on the back surface of a liquid crystal panel 51. The liquid crystal panel 51 is held to the illumination device 1 by a bezel 52 covering the perimeter of the display surface 51a on the front surface.

The illumination device 1 is configured as an edge light-type illumination device in which a light source 12 is arranged to the side of a thin plate-shaped light guide plate 11. A light guide plate assembly 10 in which the light guide plate 11 and the light source 12 are integrally held by a holding member 13 whose cross section is U-shaped is housed within an enclosure 2. The enclosure 2 is formed with a panel frame 3 that covers a perimeter portion of the emission surface 11b of the light guide plate 11 and a back chassis 4 that covers the back surface of the light guide plate 11.

The light source 12 is formed with an LED fixed to a support portion 12a; a plurality of LEDs are aligned along the entrance surface 11a of a side end surface of the light guide plate 11. Screws 14a and 14b that are inserted through the holding member 13 are screwed into the support portion 12a, and thus the light source 12 is attached to the holding member 13. The light guide plate 11 is formed of an acrylic resin or the like; optical sheets 16 are arranged on the emission surface 11b adjacent to the entrance surface 11a. On the back surface of the light guide plate 11, a reflective sheet 17 that reflects light to guide it to the emission surface 11b is arranged. Pins 15a and 15b are inserted through the upper and lower portions of the holding member 13. The pin 15a is inserted through the optical sheets 16 and the light guide plate 11; the pin 15b is inserted through the reflective sheet 17 and the light guide plate 11. Thus, the light guide plate 11 is attached to the holding member 13.

Between the back surface of the holding member 13 and the back chassis 4, a heat sink 44 is provided. The front surface, the back surface and the side surfaces of the holding member 13 are covered by a slide member 40 whose cross section is U-shaped. The front surface and the back surface of the holding member 13 are in contact with the slide member 40; a compression spring 43 is arranged between the side surfaces of the holding member 13 and the slide member 40.

Screws 42a and 42b that are inserted through the enclosure 2 are screwed into an auxiliary member 41 integral with the slide member 40, and thus the slide member 40 is attached to the enclosure 2. The tightening of the screws 42a and 42b causes the enclosure 2 to press the front surface and the back surface of the slide member 40, and the holding member 13 is sandwiched by the slide member 40. The arrangement is performed such that the tightening force of the screws 42a and 42b is set within a predetermined range and thus the holding member 13 can slide with respect to the slide member 40 with a predetermined force.

In the liquid crystal display device 50 configured as described above, light emitted from the light source 12 enters the light guide plate 11 through the entrance surface 11a. The light that has entered the light guide plate 11 is guided within the light guide plate 11, and the illumination light is emitted from the emission surface 11b. The illumination light emitted from the emission surface 11b illuminates the liquid crystal panel 51, and an image is displayed on a display surface 51a.

The light guide plate 11 thermally expands and contracts by heat emitted from the light source 12 and changes in ambient temperature. By the thermal expansion and contraction of the light guide plate 11, the holding member 13 slides and moves together with the slide member 40 against the friction force of the slide member 40 and the force of the compression spring 43. Here, since the light source 12 is held by the holding member 13, the distance between the light source 12 and the entrance surface 11a of the light guide plate 11 is held constant. Thus, it is possible to reduce the decrease in the brightness of the illumination light emitted from the emission surface 11b.

The heat emitted from the light source 12 is transmitted from the support portion 12a to the holding member 13, is transmitted through the slide member 40 and the heat sink 44 to the enclosure 2 and is discharged. The areas between the individual members are filled with heat dissipation grease, and thus it is possible to reliably transmit the heat from the light source 12 to the enclosure 2.

### RELATED ART DOCUMENT

### Patent Document

Patent document 1: JP-A-2009-32664 (Pages 7-35, FIG. 3)

### DISCLOSURE OF THE INVENTION

### Problems to be Solved by the Invention

Since the thickness and the weight of the liquid crystal display device 50 incorporated in a television receiver device or the like have been reduced year after year, it is required to reduce the thickness and the weight of the illumination device 1. However, in the conventional illumination device 1 described above, the slide member 40 is provided between the light guide plate assembly 10 and the enclosure 2, with the result that, disadvantageously, the structure is complicated and it becomes difficult to reduce the thickness of the liquid crystal display device 50.

When the thickness of the light guide plate 11 is reduced (for example, 15 mm) to decrease the thickness and the weight of the illumination device 1, the light guide plate 11 is more likely to be bent by the friction force between the slide member 40 and the holding member 13 caused by the thermal expansion and contraction of the light guide plate 11. Thus, the distribution of brightness of the illumination light emitted from the illumination device 1 is disadvantageously degraded.

When the light guide plate 11 is formed such that the thickness of the light guide plate 11 is reduced, the force of the expansion and contraction resulting from changes in temperature is reduced. Hence, it is disadvantageously difficult to assemble the illumination device 1 by appropriately adjusting the tightening force of the screws 42a and 42b and the force of the compression spring 43. Moreover, when the bezel 52 is attached to the illumination device 1, if a force in the direction of the thickness is applied to the enclosure 2, variations occur in the force for sandwiching the holding member 13 through the slide member 40. Hence, it becomes further difficult to adjust the tightening force of the screws 42a and 42b.

An object of the present invention is to provide an illumination device that can reduce the thickness and the weight thereof with a simple structure and that can achieve easy assembly by reducing the bending of a light guide plate, and is to provide a liquid crystal display device and a television receiver device using such an illumination device.

### Means for Solving the Problem

To achieve the above object, according to the present invention, there is provided an edge light-type illumination device in which a light source is arranged to the side of a thin plate-shaped light guide plate, which guides light that enters the light guide plate through an entrance surface opposite the light source and which emits planar illumination light through an emission surface, the illumination device including: a light guide plate assembly that uses a holding member having a heat dissipation portion formed with a thermal conductor extending along a back surface of the light guide plate so as to integrally hold the light source and the light guide plate; and an enclosure that covers a perimeter portion of the emission surface of the light guide plate and the back surface so as to house the light guide plate assembly, in which the position of the light guide plate assembly in a direction of a thickness of the light guide plate assembly is regulated by an inner surface of the enclosure, and a predetermined gap in the direction of the thickness is provided between the inner surface of the enclosure and the light guide plate assembly.

In this configuration, the light guide plate assembly is arranged within the enclosure in the illumination device. The light guide plate assembly integrally holds the thin plate-shaped light guide plate and the light source with the holding member. The light source is arranged opposite the entrance surface on the side end surface of the light guide plate, and the light emitted from the light source enters the light guide plate through the entrance surface. The light entering the light guide plate is guided within the light guide plate, and the planar illumination light is emitted from the emission surface adjacent to the entrance surface. Between the light guide plate assembly and the inner surface of the enclosure, a very small gap of a predetermined amount is formed, and the position of the light guide plate assembly in the direction of the thickness is regulated by the inner surface of the enclosure. When the light guide plate thermally expands and contracts by the gap, the light source and the holding member can move together within the enclosure. The holding member has the heat dissipation portion extending along the back surface of the light guide plate, and the light emitted from the light source is dissipated from the heat dissipation portion.

According to the present invention, in the illumination device configured as described above, the heat dissipation portion extends longer toward the center portion of the light guide plate than an edge of the enclosure on the side of the emission surface. In this configuration, the perimeter portion of the entrance surface of the light guide plate is covered by the enclosure, and the illumination light is emitted from the interior of the edge of the enclosure. The heat dissipation portion arranged on the back surface of the light guide plate extends longer toward the center portion of the light guide plate than the edge, and thus it is possible to acquire a larger dissipation area.

According to the present invention, in the illumination device configured as described above, a rib supporting the heat dissipation portion is so provided on the enclosure as to protrude. In this configuration, when the heat dissipation portion makes contact with the ribs, they are in point contact or in line contact, and thus the slide friction between them is reduced, and a space between the ribs is formed between the heat dissipation portion and the enclosure.

According to the present invention, in the illumination device configured as described above, the light guide plate includes a fitting portion that fits into a locating portion provided in the holding member, and the fitting portion is fitted into the locating portion such that the light guide plate is hooked on the holding member and that the light guide plate is located with respect to the holding member in a direction perpendicular to the entrance surface.

In this configuration, the fitting portion is fitted into the locating portion, and thus the light guide plate is hooked on the holding member. The gap between the fitting portion and the locating portion in the direction perpendicular to the entrance surface is formed to be very small, and the relative movement of the light guide plate with respect to the holding member is regulated.

According to the present invention, in the illumination device configured as described above, a plurality of the locating portions and a plurality of the fitting portions are provided along the entrance surface, and a distance over which the fitting portion can move with respect to one of the locating portions in a direction parallel to the entrance surface is longer than a distance over which the fitting portion can move with respect to another of the locating portions in the direction parallel to the entrance surface.

In this configuration, the locating portion and the fitting portion are provided in the vicinity of the entrance surface, for example, in both end portion. By fitting the fitting portion into one of the locating portions, the relative movement of the light guide plate with respect to the holding member both in the direction perpendicular to and in the direction parallel to the entrance surface is regulated. By fitting the fitting portion into the other locating portion, the relative movement of the light guide plate with respect to the holding member in the direction perpendicular to the entrance surface is regulated, and thus the light guide plate can thermally expand and contract in the parallel direction.

According to the present invention, in the illumination device configured as described above, the light guide plate includes, in the center portion of a side surface perpendicular to the entrance surface, an enclosure fitting portion that fits into an assembly locating portion provided in the enclosure, and the enclosure fitting portion is fitted into the assembly locating portion such that the light guide plate assembly is hooked on the enclosure and that the light guide plate assembly is located with respect to the enclosure in a direction perpendicular to the entrance surface.

In this configuration, the enclosure fitting portion is fitted into the assembly locating portion such that the light guide plate assembly is hooked on the enclosure. The gap between the enclosure fitting portion and the assembly locating portion in the direction perpendicular to the entrance surface is formed to be very small, and the relative movement of the light guide plate assembly with respect to the enclosure is regulated. Here, the enclosure fitting portion is provided in the center portion of the side surface of the light guide plate perpendicular to the entrance surface, and thus it is possible to reduce the amount of expansion and contraction in the direction perpendicular to the entrance surface in the end surface of the light guide plate.

According to the present invention, there is provided a liquid crystal display device including: the illumination device having any one of the configurations described above; and a liquid crystal panel that is arranged opposite the emission surface and that is supported by the enclosure.

According to the present invention, there is provided a television receiver device including: the liquid crystal display device configured as described above; and a drive substrate that drives the liquid crystal panel.

According to the present invention, in the television receiver device configured as described above, the enclosure has a recess portion that is recessed in an opposite surface of the heat dissipation portion, and the drive substrate is provided in the recess portion. In this configuration, the drive substrate arranged within the recess portion is covered by the enclosure.

### ADVANTAGES OF THE INVENTION

According to the present invention, since the gap that can regulate, with the inner surface of the enclosure, the position of the light guide plate assembly in the direction of the thickness within a predetermined range is provided between the light guide plate assembly and the inner surface of the enclosure, it is possible to reduce the thickness and the weight of the illumination device with a simple structure without need for a conventional slide member, and to easily assemble it. Moreover, since the friction force between the enclosure and the light guide plate assembly is significantly lowered, it is possible to reduce the bending of the light guide plate at the time of the thermal expansion and contraction even if the thickness of the light guide plate is reduced. Furthermore, since the holding member has the heat dissipation portion formed with the thermal conductor, even if the gap is provided between the light guide plate assembly and the enclosure, it is possible to easily dissipate the heat emitted from the light source.

### BRIEF DESCRIPTION OF DRAWINGS

FIG. 1 An exploded perspective view showing a liquid crystal display device incorporating an illumination device according to a first embodiment of the present invention;

FIG. 2 A side cross-sectional view showing a television receiver device incorporating the illumination device according to the first embodiment of the present invention;

FIG. 3 A plan view showing a light guide plate assembly of the illumination device according to the first embodiment of the present invention;

FIG. 4 A perspective view showing the light guide plate assembly of the illumination device according to the first embodiment of the present invention;

FIG. 5 A detailed view of the A portion of FIG. 3;

FIG. 6 A detailed view of the B portion of FIG. 3;

FIG. 7 A detailed view of the C portion of FIG. 3;

FIG. 8 A plan view showing another aspect of the C portion of FIG. 3;

FIG. 9 A plan view showing another aspect of the C portion of FIG. 3;

FIG. 10 A side cross-sectional view showing a liquid crystal display device incorporating an illumination device according to a second embodiment of the present invention;

FIG. 11 A side cross-sectional view showing a television receiver device incorporating an illumination device according to a third embodiment of the present invention; and

FIG. 12 A side cross-sectional view showing a liquid crystal display device incorporating a conventional illumination device.

### BEST MODE FOR CARRYING OUT THE INVENTION

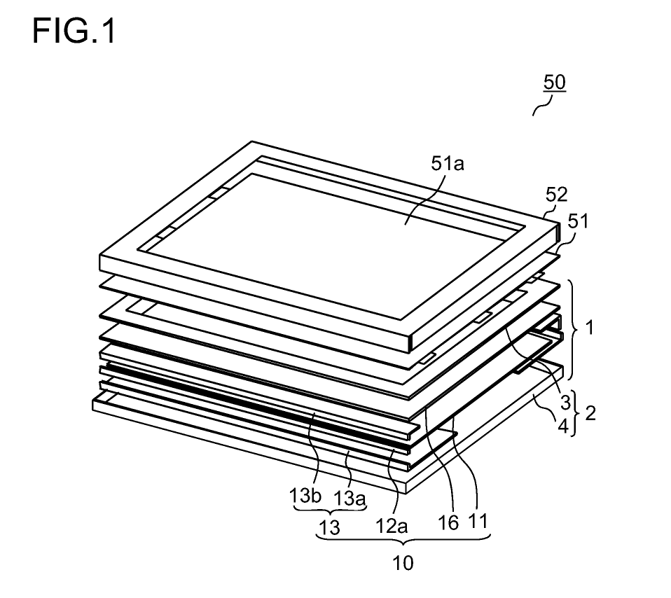

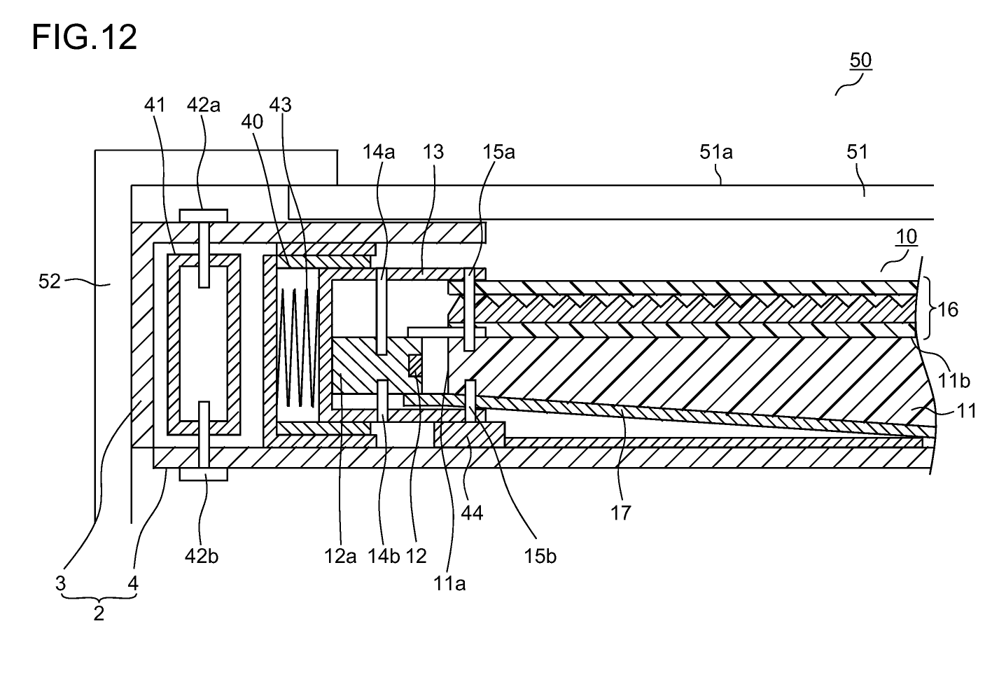

Embodiments of the present invention will be described below with reference to accompanying drawings. FIG. 1 is an exploded perspective view showing a liquid crystal display device incorporating an illumination device of a first embodiment. For ease of illustration, the same parts as in the conventional example described previously and shown in FIG. 12 are identified with the same symbols. The liquid crystal display device 50 is incorporated in a television receiver device or the like; the illumination device 1 is arranged on the back surface of a liquid crystal panel 51. The liquid crystal panel 51 is held to the illumination device 1 by a bezel 52 that covers the perimeter portion of the display surface 51a on the front surface.

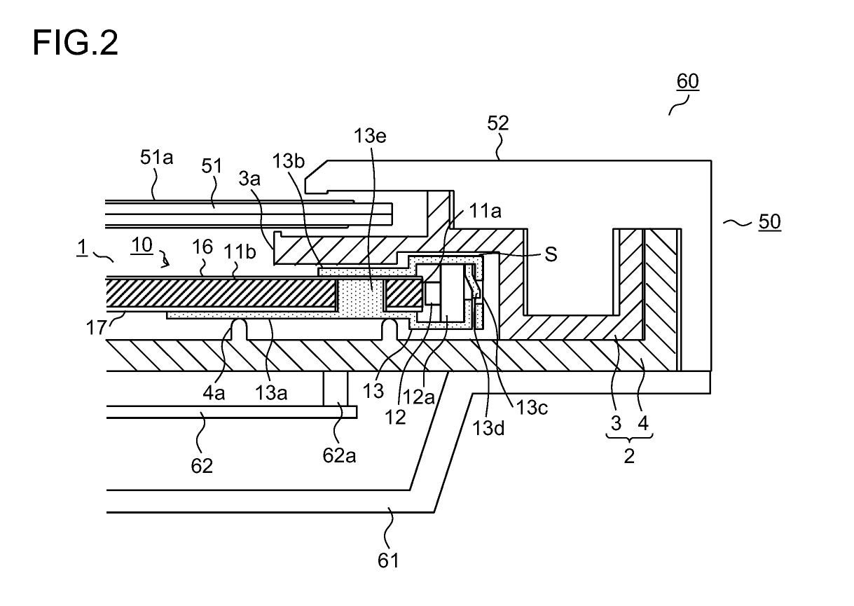

The illumination device 1 is configured as an edge light-type illumination device in which light sources 12 (see FIG. 2) are arranged to the side of a thin plate-shaped light guide plate 11. The illumination device 1 is configured in the structure of so-called two-side light entrance in which the light sources 12 are arranged along two sides opposite each other in the width direction of the rectangular light guide plate 11.

The illumination device 1 covered by the enclosure 2 houses a light guide plate assembly 10 therewithin. The enclosure 2 is formed with a panel frame 3 on the front surface side and a back chassis 4 on the back surface side. The light guide plate assembly 10 is formed by integrating, with the holding member 13, the light guide plate 11 and the light sources 12 (see FIG. 2) provided on a support portion 12a. On the emission surface 11b (see FIG. 2) of the light guide plate 11, optical sheets 16 are arranged.

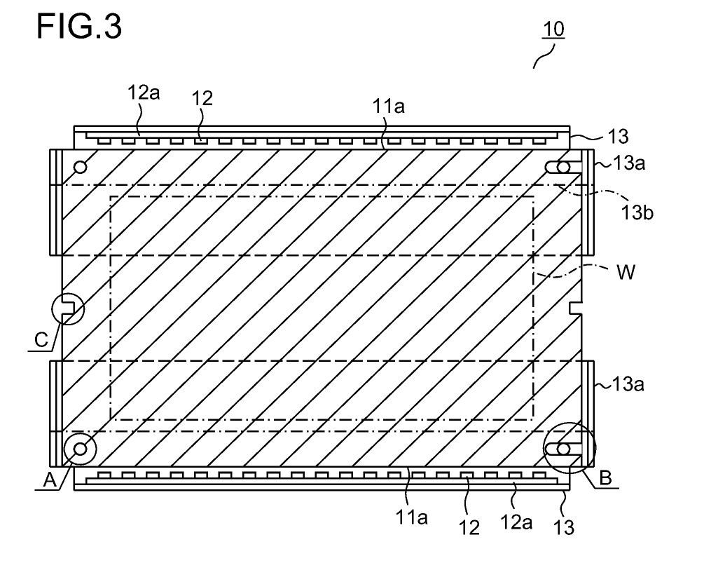

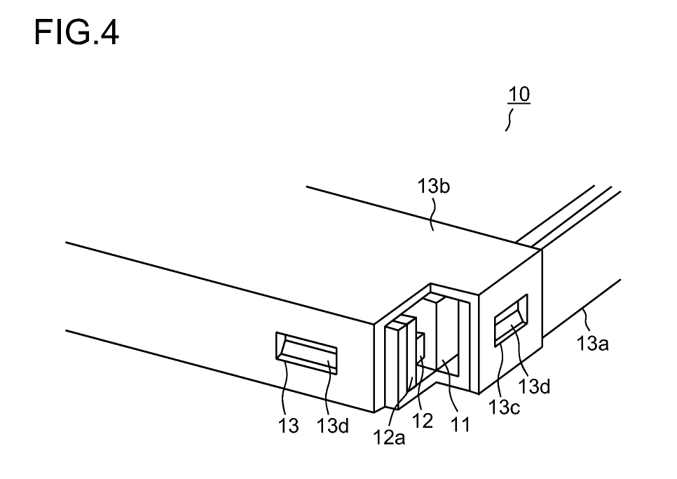

FIG. 2 shows a side cross-sectional view in a state where the liquid crystal display device 50 is incorporated in the television receiver device 60. FIGS. 3 and 4 are a plan view of the light guide plate assembly 10 and a perspective view of the main portions of the light guide plate assembly 10. The panel frame 3 forming the enclosure 2 of the illumination device 1 is formed of a resin such as polycarbonate, and covers the perimeter portion of the emission surface 1 lb of the light guide plate 11. The back surface of the liquid crystal panel 51 is supported by the panel frame 3; the liquid crystal panel 51 is sandwiched by the panel frame 3 and the bezel 52.

The back chassis 4 of the enclosure 2 is formed of a metal such iron or aluminum or a resin such as polycarbonate or a fiber-reinforced plastic (CFRP). The back chassis 4 is preferably formed of a resin because this reduces the weight. On the back chassis 4, a plurality of ribs 4a extending in a direction parallel to the entrance surface 11a of the light guide plate 11 are so provided as to protrude. Thus, the ribs 4a are in line contact with a heat dissipation portion 13a (details of which will be described later) of the light guide plate assembly 10 arranged within the enclosure 2. The ribs 4a may extend in a direction perpendicular to the entrance surface 11a; the ribs 4a may be formed to make point contact with the heat dissipation portion 13a.

A drive substrate 62 is fixed to the back surface of the back chassis 4 with a fixing member 62a. The drive substrate 62 drives the individual portions of the liquid crystal panel 51 and the television receiver device 60. A back surface cover 61 formed of resin is attached to the back surface of the liquid crystal display device 50; the drive substrate 62 is covered by the back surface cover 61.

The light guide plate assembly 10 holds the light guide plate 11 and the light sources 12 with the holding member 13. The light guide plate 11 is formed with a thin plate that is formed with a transparent member made of an acrylic resin or the like and that is rectangular in plan view. The optical sheets 16 arranged on the emission surface 11b on the front surface of the light guide plate 11 are formed with a diffusion sheet and the like. On the back surface of the light guide plate 11, a reflective sheet 17 that reflects light to guide it to the emission surface 11b is arranged. The light source 12 is formed with an LED that is mounted on the support portion 12a formed with a printed substrate; a plurality of light sources 12 are aligned along the entrance surface 11a on the side end surface of the light guide plate 11.

The holding member 13 is provided such that it is divided to correspond to two opposite sides of the light guide plate 11; the holding member 13 has a heat dissipation portion 13a arranged on the back surface of the light guide plate 11 and a front surface portion 13b arranged on the front surface side. The front surface portion 13b and the heat dissipation portion 13a cover the entrance surface 11a of the light guide plate 11 and both side surfaces thereof perpendicular to the entrance surface 11a. An engagement hook 13d provided in the heat dissipation portion 13a engages with an engagement hole 13c that is open to the front surface portion 13b, and thus the front surface portion 13b and the heat dissipation portion 13a are integrated to sandwich the light guide plate 11.

The heat dissipation portion 13a extending along the back surface of the light guide plate 11 is formed with a thermal conductor made of a metal such as aluminum, iron or magnesium or a resin; the heat dissipation portion 13a dissipates the heat emitted from the light source 12. The heat dissipation portion 13a is formed so as to extend longer toward the center portion of the light guide plate 11 than the edge 3a of the panel frame 3. Thus, it is possible to acquire a larger dissipation area of the heat dissipation portion 13a.

The front surface portion 13b is formed of a metal or a resin. The front surface portion 13b is more preferably formed with a thermal conductor because the dissipation of heat by the holding member 13 is enhanced. The front surface portion 13b is further preferably formed of the same material as the heat dissipation portion 13a because it is possible to reduce the occurrence of a bimetal phenomenon.

The support portion 12a of the light source 12 is fixed to the heat dissipation portion 13a with a fixing member (not shown) such as a screw, an adhesive or an adherence member. The fixing member is formed of a material having a high thermal conductivity, and thus it is possible to reliably transmit the heat emitted from the light source 12 to the heat dissipation portion 13a.

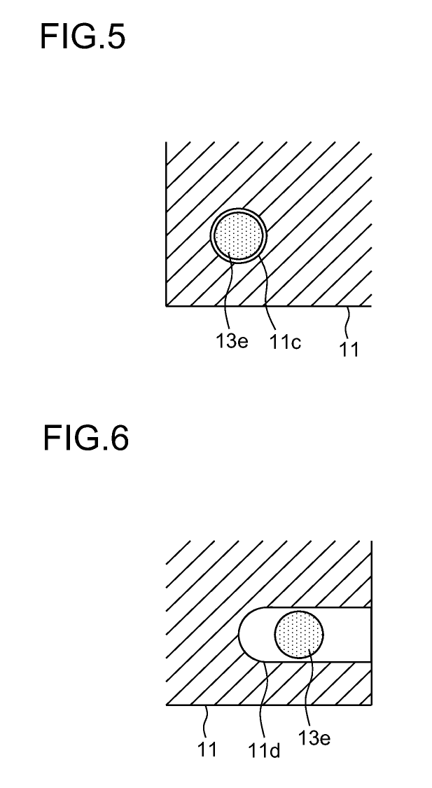

FIGS. 5 and 6 show detailed views of the A portion and the B portion of FIG. 3. Locating portions 13e are formed on the heat dissipation portion 13a of the holding member 13 so as to protrude; fitting portions 11c and 11d provided in the light guide plate 11 are fit into the locating portions 13e. In this way, the light guide plate 11 is hooked on the holding member 13, and the light source 12 and the light guide plate 11 are integrated with the holding member 13 to form the light guide plate assembly 10.

Here, gaps between the locating portions 13e and the fitting portions 11c and 11d in the direction perpendicular to the entrance surface 11a (see FIG. 2) are so formed as to be very small. In this way, the relative movement of the light guide plate 11 with respect to the holding member 13 in the direction perpendicular to the entrance surface 11a is regulated, and thus the light guide plate 11 is located. Thus, it is possible to keep short the distance between the entrance surface 11a and the light source 12.

A gap between the locating portion 13e in one end of the light guide plate 11 and the fitting portion 11c in the direction parallel to the entrance surface 11a is so formed as to be very small. In this way, the relative movement of the light guide plate 11 with respect to the holding member 13 in the direction parallel to the entrance surface 11a is regulated, and thus the light guide plate 11 is located. The relative distance over which the fitting portion 11d can move with respect to the locating portion 13e in the other end of the light guide plate 11 in the direction parallel to the entrance surface 11a is formed to be longer than the fitting portion 11c in the one end. In this way, when the temperature of the light guide plate 11 is changed, the locating portions 13e are prevented from reducing the thermal expansion and contraction in the direction parallel to the entrance surface 11a, and thus it is possible to reduce the bending of the light guide plate 11.

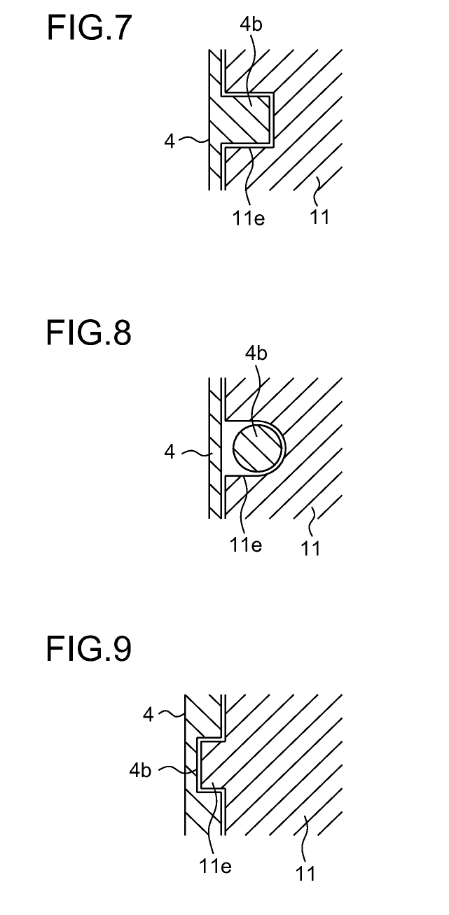

FIG. 7 shows a detailed view of the C portion of FIG. 3. In the center portion of the side surface perpendicular to the entrance surface 11a of the light guide plate 11, an enclosure fitting portion 11e that is rectangular in plan view is recessed. On the side surface of the back chassis 4, an assembly locating portion 4b that fits into the enclosure fitting portion 11e is so provided as to protrude. The enclosure fitting portion 11e is fitted into the assembly locating portion 4b, and thus the light guide plate assembly 10 is hooked on the enclosure 2.

Here, a gap between the assembly locating portion 4b and the enclosure fitting portion 11e in the direction perpendicular to the entrance surface 11a (see FIG. 2) is so formed as to be very small. In this way, the relative movement of the light guide plate assembly 10 with respect to the enclosure 2 in the direction perpendicular to the entrance surface 11a is regulated, and thus the light guide plate 11 is located.

Since the assembly locating portion 4b and the enclosure fitting portion 11e are provided in the center portion of each of both side surfaces of the light guide plate 11, the light guide plate 11 thermally expands and contracts from the enclosure fitting portion 11e in the direction of both entrance surfaces 11a. Hence, in both end surfaces where the light sources 12 of the light guide plate 11 are arranged, it is possible to reduce the amount of expansion and contraction in the direction perpendicular to the entrance surface 11a. Thus, it is possible to keep short the distance between the light guide plate assembly 10 and the enclosure 2.

As described above, a gap between the assembly locating portion 4b in one end of the light guide plate 11 and the enclosure fitting portion 11e in the direction parallel to the entrance surface 11a (see FIG. 2) is so formed as to be very small. The relative distance over which the enclosure fitting portion 11e can move with respect to the assembly locating portion 4b in the other end of the light guide plate 11 in the direction parallel to the entrance surface 11a is formed to be longer than the enclosure fitting portion 11e in the one end. Thus, it is possible to reduce the bending of the light guide plate 11 resulting from the thermal expansion and contraction in the direction parallel to the entrance surface 11a.

FIGS. 8 and 9 are plan views showing other aspects of the enclosure fitting portion 11e and the assembly locating portion 4b. As shown in FIG. 8, the enclosure fitting portion 11e may be recessed in the side surface of the light guide plate 11 such that the enclosure fitting portion 11e is D-shaped in plan view, and the assembly locating portion 4b may be formed in the shape of a cylinder extending from the back surface of the back chassis 4. As shown in FIG. 9, the assembly locating portion 4b may be recessed in the side surface of the back chassis 4 such that the assembly locating portion 4b is rectangular in plan view, and the enclosure fitting portion 11e may be provided on the side surface of the light guide plate 11 so as to protrude.

As shown in FIG. 2 described previously, a gap S in the direction of the thickness is provided between the light guide plate assembly 10 and the inner surface of the enclosure 2. This figure shows a state where the heat dissipation portion 13a is in contact with the ribs 4a; here, the gap S is formed between the front surface portion 13b and the panel frame 3. The gap S is formed to be less than a range (for example, 0.1 mm or less) within which the light guide plate assembly 10 is allowed to move in the direction of the thickness, and the position of the light guide plate assembly 10 in the direction of the thickness is regulated by the inner surface of the enclosure 2.

In consideration of the thermal expansion of the holding member 13 and the light guide plate 11, the gap S is preferably formed to be 0.01 mm or more. For example, when the heat dissipation portion 13a and the front surface portion 13b of the holding member 13 are formed with an aluminum (thermal expansion coefficient: 2.4×10⁻⁵) part having a thickness of 1 mm, the total of the expansion in the direction of the thickness when the ambient temperature is changed by 20° C. is about 0.001 mm When the light guide plate 11 is formed with an acrylic resin (thermal expansion coefficient: 7×10⁻⁵) part having a thickness of 1.5 mm, the expansion in the direction of the thickness when the ambient temperature is changed by 20° C. is about 0.002 mm Hence, the gap S is formed to be 0.01 mm or more, and thus it is possible to prevent the light guide plate assembly 10 from making contact with the inner surfaces of the enclosure 2 in the front and the back thereof due to the thermal expansion.

In the liquid crystal display device 50 configured as described above, the light emitted from the light source 12 enters the light guide plate 11 through the entrance surface 11a. The light that has entered the light guide plate 11 is guided within the light guide plate 11, and the planar illumination light is emitted from the emission surface 11b. The illumination light emitted from the emission surface 11b illuminates the liquid crystal panel 51, and an image is displayed in an image display range W (see FIG. 3) on a display surface 51a.

The light guide plate 11 thermally expands and contracts by heat emitted from the light source 12 and changes in ambient temperature. By the thermal expansion and contraction of the light guide plate 11, the light guide plate assembly 10 moves along the inner surface of the enclosure 2. Here, since the light source 12 is held by the holding member 13, the distance between the light source 12 and the entrance surface 11a of the light guide plate 11 is held constant. Thus, it is possible to reduce the decrease in the brightness of the illumination light emitted from the emission surface 11b.

Since, in the present embodiment, the gap S that can regulate, with the inner surface of the enclosure 2, the position of the light guide plate assembly 10 in the direction of the thickness within a predetermined range is provided between the light guide plate assembly 10 and the inner surface of the enclosure 2, it is possible to reduce the thickness and the weight of the illumination device 1 with a simple structure without need for a conventional slide member 40 (see FIG. 12), and to easily assemble it. Moreover, since the friction force between the enclosure 2 and the light guide plate assembly 10 is significantly lowered, it is possible to reduce the bending of the light guide plate 11 at the time of the thermal expansion and contraction even if the thickness of the light guide plate 11 is reduced. Furthermore, since the holding member 13 has the heat dissipation portion 13a formed with the thermal conductor, even if the gap S is provided between the light guide plate assembly 10 and the enclosure 2, it is possible to easily dissipate the heat emitted from the light source 12.

Since the heat dissipation portion 13a extends longer toward the center portion of the light guide plate 11 than the edge of the enclosure 2 on the side of the emission surface 11b, it is possible to acquire a larger dissipation area of the heat dissipation portion 13a.

Since the ribs 4a that support the heat dissipation portion 13a are so provided on the enclosure 2 as to protrude, it is possible to more reduce the slide friction between the light guide plate assembly 10 and the enclosure 2. Moreover, the space between the ribs 4a is formed between the heat dissipation portion 13a and the enclosure 2, and thus it is possible to enhance the efficiency of the dissipation of heat by the heat dissipation portion 13a.

The locating portions 13e are fitted into the fitting portions 11c and 11d, and thus the light guide plate 11 is hooked on the holding member 13, with the result that the light guide plate 11 is located with respect to the holding member 13 in the direction perpendicular to the entrance surface 11a. Thus, it is possible to hold the light guide plate 11 with a simple structure. Moreover, since it is possible to keep short the distance between the entrance surface 11a and the light source 12, it is possible to enhance the illumination efficiency.

Since the distance over which the fitting portion 11d can move with respect to one of the locating portions 13e in the direction parallel to the entrance surface 11a is longer than the distance over which the fitting portion 11c can move with respect to the other locating portion 13e in the direction parallel to the entrance surface 11a, the thermal expansion and contraction in the direction parallel to the entrance surface 11a is not prevented by the locating portions 13e when the temperature of the light guide plate 11 is changed. Thus, it is possible to reduce the bending of the light guide plate 11.

The assembly locating portion 4b is fitted into the enclosure fitting portion 13e, and thus the light guide plate assembly 10 is hooked on the enclosure 2, with the result that the light guide plate assembly 10 is located with respect to the enclosure 2 in the direction perpendicular to the entrance surface 11a. Thus, it is possible to hold the light guide plate assembly 10 with a simple structure. Moreover, since the assembly locating portion 4b and the enclosure fitting portion 11e are provided in the center portion of each of both side surfaces of the light guide plate 11, the light guide plate 11 thermally expands and contracts from the enclosure fitting portion 11e in the direction of both entrance surfaces 11a. Hence, in both end surfaces where the light sources 12 of the light guide plate 11 are arranged, it is possible to reduce the amount of expansion and contraction in the direction perpendicular to the entrance surface 11a. Thus, it is possible to keep short the distance between the light guide plate assembly 10 and the enclosure 2, with the result that it is possible to more reduce the size of the illumination device 1.

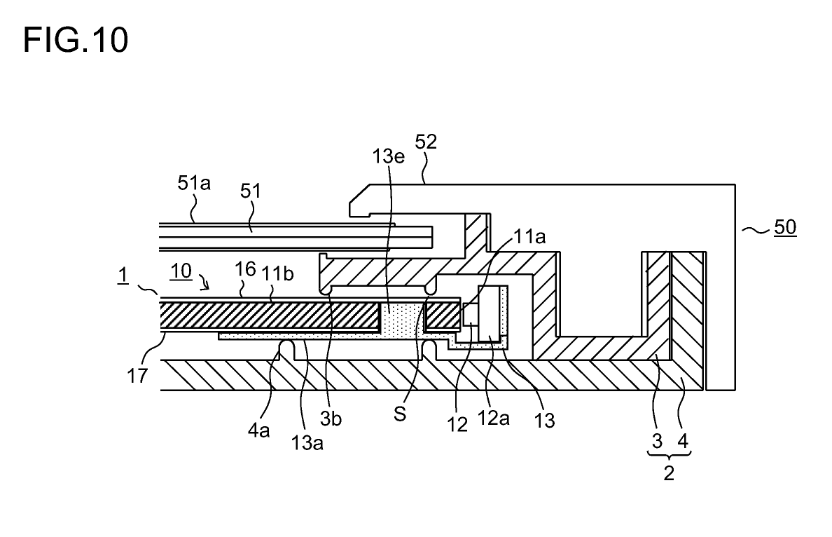

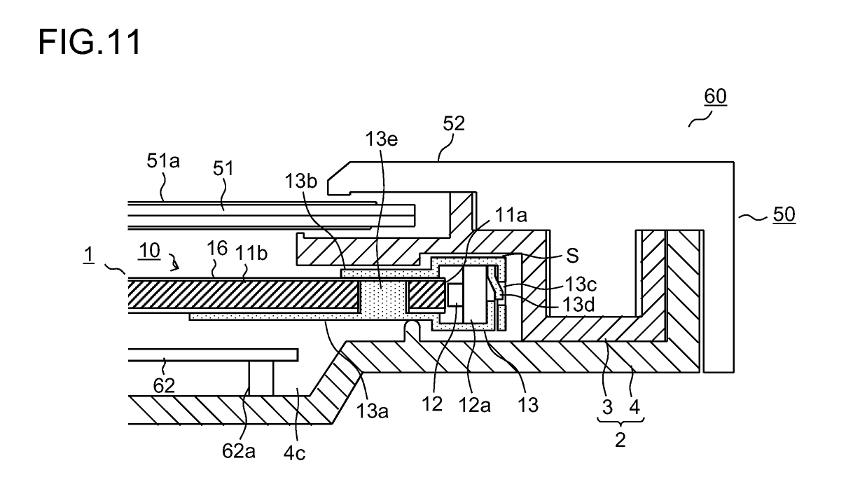

FIG. 11 shows a side cross-sectional view of the liquid crystal display device 50 incorporating an illumination device 1 according to a second embodiment. For ease of illustration, the same parts as in the first embodiment described above and shown in FIGS. 1 to 10 are identified with the same symbols. The present embodiment differs from the first embodiment in that the front surface portion 13b (see FIG. 2) of the holding member 13 is omitted. The other parts are the same as in the first embodiment.

On the panel frame 3 of the enclosure 2, a plurality of ribs 3b extending in a direction parallel to the entrance surface 11a are so provided as to protrude. Thus, the ribs 3b are in line contact with the perimeter portion of the light guide plate 11. The ribs 3b may extend in the direction perpendicular to the entrance surface 11a; the ribs 3b may be formed to make point contact with the light guide plate 11.

This figure shows a state where the heat dissipation portion 13a is in contact with the ribs 4a; here, a gap S is formed between the optical sheets 16 of the light guide plate assembly 10 and the ribs 3b of the panel frame 3. The gap S is formed to be less than a range within which the light guide plate assembly 10 is allowed to move in the direction of the thickness, and the position of the light guide plate assembly 10 in the direction of the thickness is regulated by the inner surface of the enclosure 2. Hence, by the thermal expansion and contraction of the light guide plate 11, the light guide plate assembly 10 can move along the inner surface of the enclosure 2.

According to the present embodiment, it is possible to obtain the same effects as in the first embodiment. Since the front surface portion 13b (see FIG. 2) of the holding member 13 is not provided, and the gap S is formed between the optical sheets 16 and the panel frame 3, it is possible to more reduce the thickness of the illumination device 1.

FIG. 12 shows a side cross-sectional view of the liquid crystal display device 50 incorporating an illumination device 1 according to a third embodiment and shows a state where the liquid crystal display device 50 is incorporated in the television receiver device 60. For ease of illustration, the same parts as in the first embodiment described above and shown in FIGS. 1 to 10 are identified with the same symbols. The present embodiment differs from the first embodiment in the structure of the back chassis 4. The other parts are the same as in the first embodiment.

In the back chassis 4, a recess portion 4c that is recessed between the ribs 4a in the opposite surface of the heat dissipation portion 13a is provided. The drive substrate 62 is fixed to the recess portion 4c with the fixing member 62a; the drive substrate 62 is covered by the back chassis 4. Thus, it is possible to omit the back surface cover 61 (see FIG. 2) of the television receiver device 60.

According to the present embodiment, it is possible to obtain the same effects as in the first embodiment. Since the enclosure 2 has the recess portion 4c that is recessed in the opposite surface of the heat dissipation portion 13a, and the drive substrate 62 is arranged in the recess portion 4c, it is possible to omit the back surface cover 61 of the television receiver device 60. Thus, it is possible to more reduce the thickness and the weight of the television receiver device 60 incorporating the illumination device 1. The recess portion 4c where the drive substrate 62 is arranged may be provided in the illumination device 1 of the second embodiment.

Although, in the first to third embodiments, the illumination device 1 is configured in the structure of two-side light entrance, the illumination device 1 may be configured in the structure of one-side light entrance in which the light sources 12 are arranged along only one side of the light guide plate 11 or the illumination device 1 may be configured in the structure of four-side light entrance in which the light sources 12 are arranged along the four sides. In the structure of four-side light entrance, the holding members 13 for the sides of the light guide plate 11 are provided separately.

### INDUSTRIAL APPLICABILITY

The present invention can be utilized in devices such as a television receiver device that use an edge light-type illumination device.

### LIST OF REFERENCE SYMBOLS

1 illumination device
2 enclosure
3 panel frame
3b rib
4 back chassis
4a rib
4b assembly locating portion
4c recess portion
10 light guide plate assembly
11 light guide plate
11c, 11d fitting portion
11e enclosure fitting portion
12 light source
12a support portion
13 holding member
13a heat dissipation portion
13b front surface portion
13e locating portion
16 optical sheet
17 reflective sheet
40 slide member
41 auxiliary member
43 compression spring
44 heat sink
50 liquid crystal display device
51 liquid crystal panel
52 bezel
60 television receiver device
61 back surface cover
62 drive substrate

1. An edge light-type illumination device in which a light source is arranged to a side of a thin plate-shaped light guide plate, which guides light that enters the light guide plate through an entrance surface opposite the light source and which emits planar illumination light through an emission surface, the illumination device comprising:
a light guide plate assembly that uses a holding member having a heat dissipation portion formed with a thermal conductor extending along a back surface of the light guide plate so as to integrally hold the light source and the light guide plate; and
an enclosure that covers a perimeter portion of the emission surface of the light guide plate and the back surface so as to house the light guide plate assembly,
wherein a position of the light guide plate assembly in a direction of a thickness of the light guide plate assembly is regulated by an inner surface of the enclosure, and a predetermined gap in the direction of the thickness is provided between the inner surface of the enclosure and the light guide plate assembly.

2. The illumination device of claim 1,
wherein the heat dissipation portion extends longer toward a center portion of the light guide plate than an edge of the enclosure on a side of the emission surface.

3. The illumination device of claim 1,
wherein a rib supporting the heat dissipation portion is so provided on the enclosure as to protrude.

4. The illumination device of claim 1,
wherein the light guide plate includes a fitting portion that fits into a locating portion provided in the holding member, and the fitting portion is fitted into the locating portion such that the light guide plate is hooked on the holding member and that the light guide plate is located with respect to the holding member in a direction perpendicular to the entrance surface.

5. The illumination device of claim 4,
wherein a plurality of the locating portions and a plurality of the fitting portions are provided along the entrance surface, and a distance over which the fitting portion can move with respect to one of the locating portions in a direction parallel to the entrance surface is longer than a distance over which the fitting portion can move with respect to another of the locating portions in the direction parallel to the entrance surface.

6. The illumination device of claim 1,
wherein the light guide plate includes, in a center portion of a side surface perpendicular to the entrance surface, an enclosure fitting portion that fits into an assembly locating portion provided in the enclosure, and the enclosure fitting portion is fitted into the assembly locating portion such that the light guide plate assembly is hooked on the enclosure and that the light guide plate assembly is located with respect to the enclosure in a direction perpendicular to the entrance surface.

7. A liquid crystal display device comprising:
the illumination device of any one of claims 1 to 6; and
a liquid crystal panel that is arranged opposite the emission surface and that is supported by the enclosure.

8. A television receiver device comprising:
the liquid crystal display device of claim 7; and
a drive substrate that drives the liquid crystal panel.

9. The television receiver device of claim 8,
wherein the enclosure has a recess portion that is recessed in an opposite surface of the heat dissipation portion, and the drive substrate is provided in the recess portion.
